(19) United States
(12) Patent Application Publication
(10) Pub. No.: US 2014/0316992 A1
(43) Pub. Date: Oct. 23, 2014

(54) METHOD FOR CHARGING AN ONBOARD-UNIT WITH AN ELECTRONIC TICKET

(71) Applicant: Kapsch TrafficCom AG, Vienna (AT)

(72) Inventors: Robert Povolny, Wien (AT); Oliver Nagy, Wien (AT)

(73) Assignee: Kapsch TrafficCom AG, Vienna (AT)

(21) Appl. No.: 14/253,655

(22) Filed: Apr. 15, 2014

(30) Foreign Application Priority Data
Apr. 19, 2013 (EP) 13164396.7

(51) Int. Cl. G06Q 20/04; G06Q 20/38

(52) U.S. Cl. CPC G06Q 20/0457; G06Q 20/3829
USPC 705/71

(57) ABSTRACT

Methods are disclosed for charging an onboard unit with an electronic ticket and redeeming the ticket at a radio beacon. The onboard unit has a DSRC interface for radio communication with the radio beacon and a second interface for radio communication with a mobile phone. The second interface is separate from the DSRC interface. The onboard unit is provided with a public and a private electronic key of the onboard unit. In the mobile telephone, an encrypted ticket is received and the encrypted ticket is sent to the onboard unit. In the onboard unit, the encrypted ticket is received, the received ticket is decrypted, and the ticket is transmitted to the radio beacon for redemption.

### CROSS-REFERENCE TO RELATED APPLICATION(S)

This application claims priority to European Patent Application No. 13 164 396.7, filed on Apr. 19, 2013, the entirety of which is incorporated by reference herein.

### BACKGROUND

1. Technical Field

The present subject matter relates to methods for charging and redeeming electronic tickets in a traffic telematics system.

2. Background Art

Traffic telematics systems are used for a large number of different applications, whether for electronic identification of a vehicle or for payment of road, access, area or city charges, for payment of parking fees, for access control (for example barrier systems), for electronic vehicle registration (EVR), etc. For this purpose, onboard units (OBUs) are often equipped with a short-range communication module in accordance with the DSRC (dedicated short range communication) standard so that they can be localised to the local radio coverage range of an interrogating radio beacon.

Here, electronic tickets can be charged in onboard units and then used for redemption at a wide range of types of radio beacon, for example in order to pay at a radio beacon a road toll fee (“toll fee ticket”), in order to pay a parking fee (“parking ticket”), in order to pay an entrance fee (“entrance ticket”), or in order to settle payment of goods or services, for example for a weather service, data service, information or entertainment service, or the like.

In order to ensure the integrity of such an electronic ticket over the transmission path between, for example, a ticket-issuing central system, a ticket-transporting onboard unit and a ticket-redeeming radio beacon, symmetrical key pairs are currently used in known traffic telematics systems and have to be exchanged by the communication partners before the communication. This requires a secured key distribution method, with correspondingly high outlay in terms of time, organisation and cost.

Document WO 2009/082748 A1 describes a payment system in a vehicle wherein an onboard unit communicates with a merchant via a transceiver. To conduct a transaction, a reader of the onboard unit recognizes, e.g., a mobile phone which accesses an online account via an internet connection, whereupon the transaction is processed via the online account and/or the onboard unit sends payment information (e.g., credit card number) to the merchant. The radio communication between the onboard unit and the merchant can be secured, e.g., by means of an encryption system using private and public keys.

Document WO 02/042225 A2 shows an encryption of tickets by means of public and private keys: The tickets are encrypted by a central station with a public key of, e.g., a mobile phone, whereupon the encrypted ticket is sent to the mobile phone. The mobile phone can then decrypt the ticket with its private key and redeem it at a redeeming system.

### BRIEF SUMMARY

An object of the disclosed subject matter is to overcome the disadvantages of the presented art and to create an improved ticket-issuing and ticket-redeeming method for electronic tickets in a traffic telematics system.

This object is achieved in a first aspect with a method for charging an onboard unit with an electronic ticket and redeeming said ticket or a ticket derived therefrom at a radio beacon of a traffic telematics system, wherein the onboard unit has a DSRC interface for radio communication with the radio beacon and a second interface for radio communication with a mobile phone, said second interface being separate from the DSRC interface, comprising:

providing the onboard unit with a public and a private electronic key of the onboard unit;

in the mobile telephone, receiving the public onboard unit key from the onboard unit,

transmitting a ticket request with the public onboard unit key to a central system via the mobile network,

receiving a ticket encrypted with the public onboard unit key via the mobile radio network from the central system,

sending the ticket encrypted with the public onboard unit key from the mobile phone to the onboard unit;

in the onboard unit, receiving via the second interface of the onboard unit the ticket encrypted with the public onboard unit key,

decrypting the received ticket using the private onboard unit key, and

transmitting the ticket or a ticket derived therefrom via the DSRC interface to the radio beacon for redemption.

In the present description, DSRC and a DSRC interface are understood to mean a short-range communication via a radio range of at most a few metres, a few tens of metres or a few hundred metres, as is implemented for example by the DSRC (dedicated short range communication), CEN-DSRC, UNI-DSRC, IEEE 802.11p or WAVE (wireless access for vehicular environments) or ITS-G5 standards, including WLAN and Wifi®, Bluetooth® or also active and passive RFID (radio frequency identification) technologies.

An embodiment relates to the use of asymmetric encryption methods (“public/private key encryption”) and a separate interface, suitable for this encryption, of the onboard unit, via which interface the ticket can be brought into (charged) in the onboard unit. The asymmetric encryption eradicates the need for a secured key distribution method, as is necessary in the case of symmetric keys. Any onboard unit can thus be provided with its own key pair formed of public and private onboard unit keys, for example during the manufacturing process, without the need for the other communication partners, for example the ticket issuer, to know the private onboard unit keys during operation.

The use of a mobile telephone, in particular of an NFC-enabled mobile telephone and an NFC interface between mobile telephone and DSRC onboard unit, facilitates the handling process here and the secured, encrypted ticket transfer from the central system to the onboard unit with the aid of a mobile network (public land mobile network, PLMN) on the one hand and a wireless or NFC radio interface on the other hand.

In an embodiment, the second interface may be a wireless interface, such as an NFC interface, which substantially simplifies the handling of the charging of an onboard unit with an electronic ticket. NFC (near field communication) is a radio communication technology via extremely short radio ranges of at most a few centimetres or a few tens of centimetres and therefore requires close proximity of the onboard unit in order to establish the communication and to bring the ticket into the onboard unit, which gives the user assurance of addressing precisely this onboard unit.

An example embodiment is characterised in that the radio beacon is provided with a public and a private electronic key of the radio beacon or of a central system of the traffic telematics system, and in that the decrypted ticket or the ticket derived therefrom before the transmission to the radio beacon is re-encrypted in the onboard unit using the public radio beacon or public central system key. The ticket or derived ticket may then, for example, be decrypted in the radio beacon using the private radio beacon key or private central system key.

This embodiment is based on a trusted onboard unit, in which a key change is implemented from a first encryption between ticket-issuing central system and ticket-transporting onboard unit on the one hand to a second encryption between ticket-transporting onboard unit and ticket-redeeming radio beacon on the other hand. Ticket issuers (for example central systems) and ticket redeemers (radio beacons) therefore require no knowledge from one another concerning private keys, thus facilitating the handling and key distribution significantly.

In a further aspect the method also comprises the issuing of the ticket in a central system of the traffic telematics system provided with a public and a private electronic key, specifically comprising the following steps:

issuing the ticket;

signing the ticket using the private central system key;

encrypting the ticket using the public onboard unit key; and

transmitting the encrypted ticket to the onboard unit via the second interface thereof.

In the onboard unit, the ticket may, for example, be validated with the aid of the public central system key and only then, if it is valid, is the ticket or the ticket derived therefrom transmitted to the radio beacon for redemption. Therefore, not only can the change of the encryption be performed in the trusted environment of the onboard unit, but also an additional security check of the validity of the ticket, if desired.

Alternatively or additionally, the ticket or the ticket derived therefrom can also be validated in the radio beacon with the aid of the public central system key and only then redeemed if valid.

The public radio beacon key or public central system key (depending on which of these keys is necessary) can be stored in the onboard unit, for example during the manufacturing process. Alternatively, this may also occur “on the fly”, that is to say the public radio beacon key or central system key may, for example, be transmitted from the radio beacon via the DSRC interface to the onboard unit.

The public central system key may also be transmitted together with the ticket or the derived ticket, however.

In accordance with a further example feature, the ticket is provided with a unique identification in the central system, and it is checked in the onboard unit whether the identification of a received ticket is contained in a list of stored identifications, and only then, if it is not contained, is the ticket or the ticket derived therefrom transmitted to the radio beacon for redemption.

It is thus ensured that no malversations can occur during the charging process: an electronic ticket issued by the central system and brought into the onboard unit has a unique identification, which is “used up” in the event of a charging process, since it is now stored in the list of the onboard unit and is no longer valid in the event of a subsequent charging process.

The electronic ticket can be stored in the onboard unit, that is to say transported thereby and then later redeemed in this form at the radio beacon. Alternatively, the ticket in the onboard unit can be introduced into an electronic purse of the onboard unit and the derived ticket can then optionally be derived from the electronic purse. The derived ticket for example has a fraction or a multiple of the monetary value of the original electronic ticket: a plurality of “smaller” derived tickets for redemption at radio beacons can be generated from an electronic ticket stored in the onboard unit via the electronic purse, or a plurality of electronic tickets loaded into the electronic purse can together form a “larger” derived ticket. The electronic purse with the electronic ticket(s) contained therein thus constitutes a “deposit”, from which it is possible to “pay” via the DSRC interface at radio beacons with the aid of the tickets derived therefrom.

The aforementioned unique identification of the ticket may be a transaction identification or, in the simplest case, also merely a timestamp.

Further features and advantages, as well as the structure and operation of various embodiments, are described in detail below with reference to the accompanying drawings.

### BRIEF DESCRIPTION OF THE DRAWINGS/FIGURES

The present subject matter will be explained in greater detail hereinafter on the basis of exemplary embodiments illustrated in the accompanying drawings, in which:

FIG. 1 shows a first embodiment of the method on the basis of signal flows between the involved components.

FIG. 2 shows a second embodiment of the method in the same representation as in FIG. 1.

FIG. 3 shows a third embodiment of the method in the same representation as in FIG. 1.

Embodiments will now be described with reference to the accompanying drawings.

### DETAILED DESCRIPTION

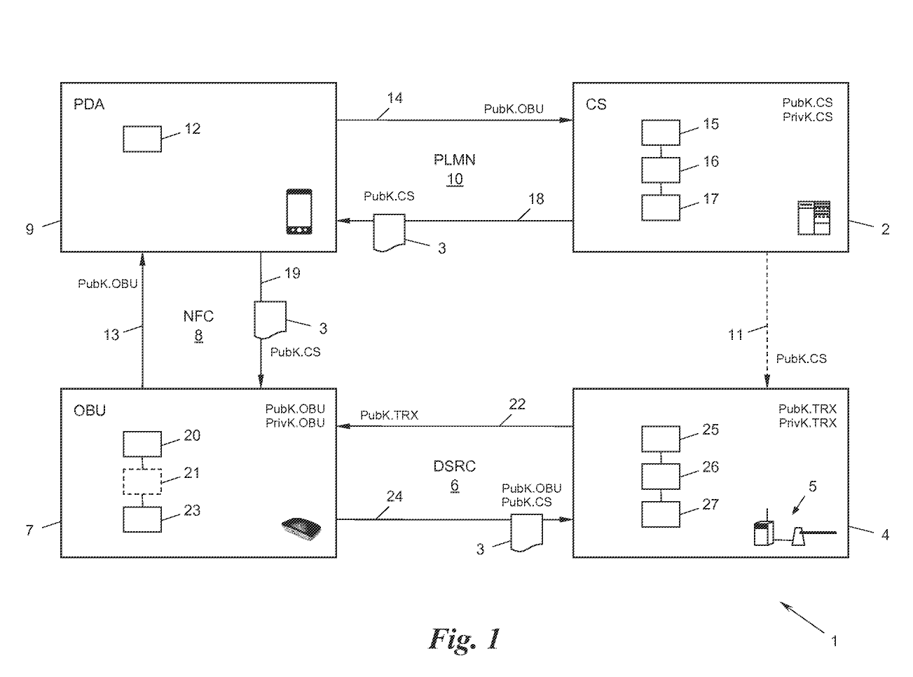

FIG. 1 shows a traffic telematics system 1, of which a central system 2 for issuing electronic tickets and (representative for a plurality of radio beacons of the system 1) a radio beacon 4 for redeeming such an electronic ticket are illustrated. The central system 2 may be a central processor of a road toll system, parking fee system, communication system, or the like, for example.

The electronic ticket 3 is a file which represents an actual value, for example authorised for the purchase of a service, such as the entrance to an area or building (“entrance ticket”), for use of a parking space (“parking ticket”), the use of a section of road or an area (“toll fee ticket”), or generally the purchase of goods or services (“electronic money”).

The radio beacon 4 is an electronic system, at which the electronic ticket 3 can be redeemed in order to authorise entry, parking, road use or goods or services. For example, the radio beacon 4 is arranged at a road (road side entity, RSE) in order to charge for the use of a section of said road by redeeming an electronic ticket 3. Alternatively, the radio beacon 4 is a parking meter, at which an electronic ticket 3 is redeemed in order to pay for a parking space. The radio beacon 4, as is illustrated symbolically at 5, alternatively may be part of a barrier system, which releases an entrance barrier upon redemption of an electronic ticket 3, etc., etc.

The radio beacon 4 is formed in accordance with the DSRC (dedicated short range communication) standard and is designed to establish DSRC radio communication with DSRC onboard units (OBUs) 7 via a DSRC radio interface 6. Such an OBU 7 is carried for example by a vehicle (not illustrated), for example is attached to the inner side of the windscreen, but may also be carried by the user where appropriate.

In the present description, DSRC and a DSRC interface are understood to mean a short-range communication via a radio range of at most a few metres, a few tens of metres or a few hundred metres, as is implemented for example by the DSRC (dedicated short range communication), CEN-DSRC, UNI-DSRC, IEEE 802.11p or WAVE (wireless access for vehicular environments) or ITS-G5 standards, including WLAN and Wifi®, Bluetooth® or also active and passive RFID (radio frequency identification) technologies.

The DSRC-OBU 7 is provided, in addition to its DSRC interface 6, with a further interface 8, which may be a radio interface according to the NFC (near field communication) standard, via which it can establish communication with a mobile telephone 9 (which may be, for example, NFC-enabled for this purpose). The mobile telephone 9 may in turn communicate with the central system 2 via a mobile network (public land mobile network, PLMN) 10 and possibly further data networks (not illustrated), for example the Internet. The interface 8 can alternatively also be produced by WLAN, Bluetooth or wired communication (for example USB, SD memory cards, or the like).

Here, the term “mobile telephone” 9 includes any type of communication device that can communicate in a mobile network 10 and that is additionally provided with an NFC interface 8, for example a cordless telephone, Smartphone, notebook PC or tablet PC, personal digital assistant (PDA), etc. The radio range of the NFC interface 8 is designed exclusively for the near-range, that is to say is limited to a few centimetres or a few tens of centimetres, such that the mobile telephone 9 has to be brought into the direct vicinity of the DSRC-OBU 7 in order to be able to carry out NFC radio communications via the NFC radio interface 8.

For the ticket charging, issuing and redemption methods presented hereinafter, the specified components, that is to say the central system 2, radio beacon(s) 4 and DSRC-OBU(s) 7, of the traffic telematics system 1 are provided as follows with electronic key pairs each formed of a public and a private key of a public/private key encryption method. As is known in the art, in the case of public/private key encryption methods, each subscriber receives two keys, specifically a public key, which is known to all other subscribers, and a private key, which is kept secret. A message—for example the electronic ticket 3 in this case—can be encrypted by a transmitter with the aid of the public key of the receiver and can then only be decrypted by the receiver using the private key thereof. Conversely, a message can be signed by a transmitter using the private key thereof. The receiver of the message can check the validity of the signing by the transmitter with the public key of the transmitter, that is to say can thus validate the signature of the transmitter.

For this purpose, the central system 2 has a public key PubK.CS and a private key PrivK.CS; each DSRC-OBU 7 has a public key PubK.OBU and a private key PrivK.OBU; and, at least in the first embodiment of the method, but not necessarily in the other embodiments of the method, each radio beacon 4 has a public key PubK.TRX and a private key PrivK.TRX. The public key PubK.TRX of the central system 2 is provided to the radio beacon 4 via a separate data path 11; or alternatively is transmitted together with an electronic ticket 3, as will be explained further below, in which case it is possible to dispense with the data path 11. For example, the data path 11 may be the Internet, an intranet or a mobile network, or also a physical transport path for a data carrier, over which the public key PubK.CS is transported from the central system 2 to the radio beacon 4.

The ticket charging, issuing and redemption method illustrated in FIG. 1 functions as follows. The ticket charging is initiated by the user at the mobile telephone 9, for which purpose he uses a corresponding application on his Smartphone, tablet PC, etc., for example, or sends and/or receives a corresponding SMS (short message service) message (step 12). In order to request the ticket 3 from the central system 2, the public key PubK.OBU, in a first step 13, is then requested from the OBU 7 via the interface 8 and is received, via NFC, for example. The mobile telephone 9 now transmits a ticket request message 14, which also contains the public key PubK.OBU of the OBU 7, via the mobile network 10 (and possibly further intermediate data networks) to the central system 2.

In the central system 2, a new electronic ticket 3 is generated and is provided for example with a unique ticket identification TK, for example a transaction ID or a timestamp. The issued ticket 3 is now signed in the central system 2 using the private central system key PrivK.CS and is encrypted using the public OBU key PrivK.OBU received previously in the ticket request 14. The signed and encrypted ticket 3 is sent back to the mobile telephone 9 via the mobile network 10 (step 18), possibly together with the public central system key Pubk.CS.

The mobile telephone 9 transmits the signed and encrypted ticket 3, received via the mobile interface 10, to the OBU 7 via the interface 8, via NFC (step 19) for example. In the OBU 7, the signed and encrypted ticket 3 is decrypted using the private OBU key PrivK.OBU (step 20). The now decrypted, yet signed ticket 3 can optionally be validated with the aid of the public central system key PubK.CS, that is to say the validity of the signature of the central system 2 can be checked (step 21). If the check fails, that is to say the signature is not authentic and therefore the ticket 3 is invalid, the ticket 3 can be rejected and/or the method terminated.

The OBU 7 then encrypts again (“re-encrypts”) the decrypted ticket 3 signed by the central system, specifically this time, in the embodiment shown in FIG. 1, using the public radio beacon key PubK.TRX (step 23). The public radio beacon key PubK.TRX may have been distributed to all OBUs 7 at the start of the method, or the OBU 7, previously in a step 22, requests via the DSRC radio interface 6 the public radio beacon key PubK.TRX from the radio beacon 4 at which it would like to redeem the ticket 3. The re-encrypted ticket 3 is then transmitted via the DSRC interface 6 to the radio beacon 4 for redemption (step 24).

In the radio beacon 4 the received, signed and re-encrypted ticket 3 is decrypted using the private radio beacon key PrivK.TRX (step 25), and the authenticity of its signature is then checked (validated) in step 26 with the aid of the public central system key PubK.CS: if the ticket 3 actually originates from the central system 2 (signature valid), the ticket 3 is then redeemed in a step 27. As explained, the redemption 27 may result in corresponding goods or services, an entrance authorisation, parking fee authorisation or toll fee authorisation, or the like.

Here, the public central system key PubK.CS can accompany the ticket 3 in all transmission steps 18, 19, 24, or alternatively may be transmitted once via the connection 11 from the central system 2 to the radio beacon 4.

Of course, some time may pass between the receipt 19 of the signed and encrypted ticket 3 from the mobile telephone 9 in the OBU 7 and the transmission 24 of the re-encrypted and signed ticket 3 from the OBU 7 to the ticket-redeeming radio beacon 4, during which time the ticket 3 is present in the OBU 7 and is transported thereby. Here, the decryption (step 20), the (optional) validation 21 and the new encryption 23 in the DSRC-OBU 7 take place in a secured hardware and/or software environment, for example in a cryptographically and/or physically secured “trusted element” in the OBU 7, or the OBU itself constitutes this “trusted element”. The central system 2 or the operator of the traffic telematics systems 1 can thus be sure that the key change, that is to say the decryption and re-encryption of the ticket 3, is performed correctly in the OBU 7. The ticket issuing of the central system 2, the mobile telephone 9 constituting a communication medium, and the ticket-redeeming radio beacon 4 are thus decoupled from one another in respect of their respective key pairs and require nothing more than the specified connections; if the data path 11 is also omitted and the public central system key PubK.CS is transported together with the ticket 3, there is in particular no direct connection between the ticket-issuing central system 2 and ticket-redeeming radio beacon 4.

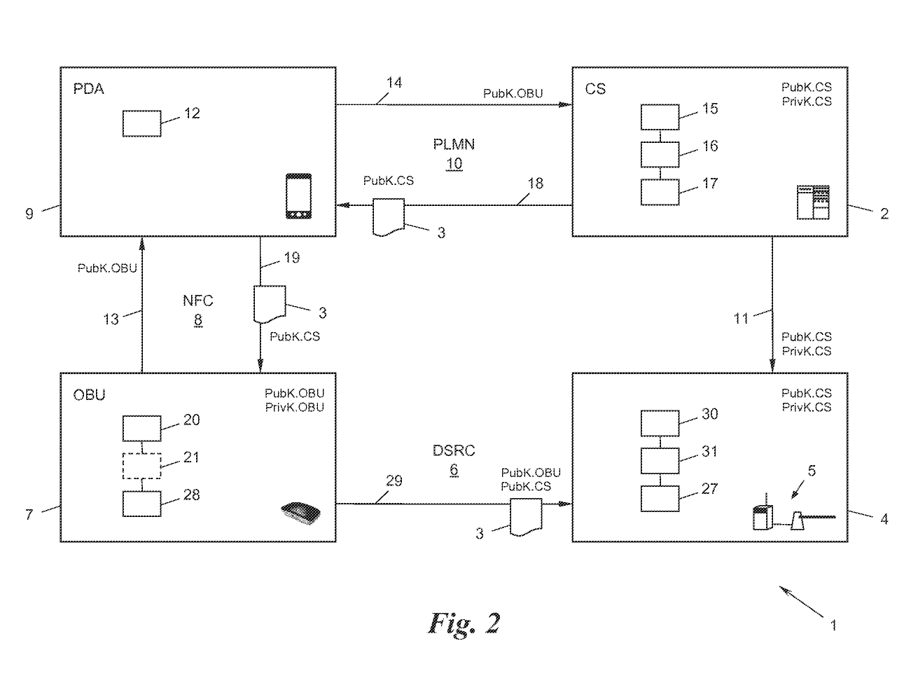

FIG. 2 shows a slightly modified embodiment of the method from FIG. 1. Steps 12 to 21 are the same as with the method from FIG. 1. To re-encrypt the ticket 3 in the OBU 7, the public radio beacon key PubK.TRX by contrast is not used in this embodiment, but instead the public central system key PubK.CS (step 28), and the ticket 3 thus signed and encrypted is transmitted to the radio beacon 4 via the DSRC interface 6 (step 29). In the radio beacon 4, the signed and re-encrypted ticket 3 is now decrypted using the private central system key PrivK.CS (step 30), and the signature of the signed ticket 3 is then validated again with the aid of the public central system key PubK.CS (step 31) before redemption occurs (step 27).

The public central system key PubK.CS can again be transported here together with the ticket 3 or can be transmitted once via the data path 11 from the central system 2 to the radio beacon 4. In addition, the radio beacon 4 here also requires knowledge of the private central system key PrivK.CS, which can be provided likewise via the data path 11. Since the public and the private central system keys PubK.CS, PrivK.CS hardly change or do not change at all, a seldom or one-time transmission via the data path 11 is sufficient here.

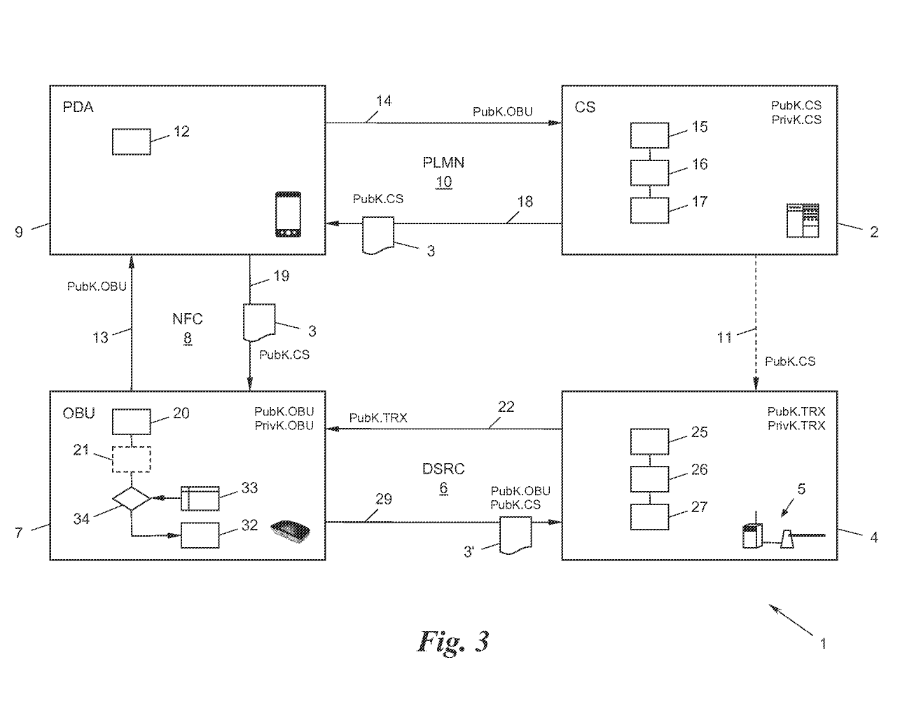

FIG. 3 shows a further method variant, in which the ticket 3 is first introduced into an electronic purse 32 in the OBU 7. This introduction may consist for example of the crediting of a specific monetary value to the electronic purse 32, wherein this may be a standardised, predefined monetary value or a monetary value that is specified in the electronic ticket 3.

The method of FIG. 3 progresses in steps 12 to 21 similarly to the method in FIGS. 1 and 2, wherein, in the event of the ticket issuing 15 in the central system 2, the ticket 3 is in any case provided with a unique identification TK, for example a transaction ID or a timestamp. A list 33 of ticket identification TK of previously obtained electronic tickets 3 is stored in the OBU 7, and the ticket identifications TK of each new electronic ticket which is brought (19) from the central system 2 into the DSRC-OBU 7 via the mobile telephone 9 and the NFC interface 8 is cross-checked in a step 34 with the list 33 of stored ticket identifications: if the ticket identification TK of the current electronic ticket 3 is present in the list 33, the electronic ticket 3 has then clearly already been used once, and it is rejected or the further course of the method is terminated. If the identification is not contained in the list 33, it is introduced into the electronic purse 32, and at the same time the ticket identification TK of the current electronic ticket 3 just redeemed is stored in the list 33 of stored ticket identifications. The electronic ticket 3 is therefore “used up”.

The tickets 3 introduced into the electronic purse 32, for example in the form of a credit balance of the electronic purse 32 accumulated on the basis of the tickets, can be used subsequently, for example to carry out conventional prepaid DSRC fee transactions with a radio beacon 4, in order to debit the electronic purse 32, for example by means of a DSRC transaction via the DSRC interface 6, or to debit the electronic purse progressively. Alternatively, one or more “new” electronic tickets 3′ can be derived in the DSRC-OBU 7 from the credit balance or the introduced ticket(s) 3 of the electronic purse 32, said “new” electronic ticket(s) also being referred here as derived tickets 3′, which can then be redeemed at a radio beacon in accordance with the method variants illustrated in FIGS. 1 and 2 (steps 24 to 31). One or more derived tickets 3′ can thus be generated (derived) from an introduced ticket 3 via the “buffer” of the electronic purse 32, or a derived ticket 3′ can be generated from one or more introduced tickets 3.

The ticket 3, the account balance of the electronic purse 32 and/or the derived ticket(s) 3′ can optionally be signed in the OBU 7 using the private OBU key PrivK.OBU, whether for a conventional DSRC toll fee transaction or DSRC parking fee transaction or for the generation of signed, derived tickets 3′, which are redeemed at a radio beacon 4 in accordance with steps 23 to 31; the redeeming radio beacon 4 can then validate the authenticity of the tickets 3, 3′ on the basis of the public OBU key PubK.OBU.

### Conclusion

The invention is not limited to the presented embodiments, but includes all variants and modifications that fall within the scope of the accompanying claims.

What is claimed is:

1. A method for charging an onboard unit with an electronic ticket and redeeming said ticket or a ticket derived therefrom at a radio beacon of a traffic telematics system, wherein the onboard unit has a DSRC (dedicated short range communication) interface for radio communication with the radio beacon and a second interface for radio communication with a mobile phone, said second interface being separate from the DSRC interface, comprising:
providing the onboard unit with a public and a private electronic key of the onboard unit;
in the mobile telephone:
receiving the public onboard unit key from the onboard unit,
transmitting a ticket request with the public onboard unit key to a central system via the mobile network,
receiving a ticket encrypted with the public onboard unit key via the mobile radio network from the central system, and
sending the ticket encrypted with the public onboard unit key from the mobile phone to the onboard unit; and
in the onboard unit:
receiving via the second interface of the onboard unit the ticket encrypted with the public onboard unit key,
decrypting the received ticket using the private onboard unit key, and
transmitting the ticket or a ticket derived therefrom via the DSRC interface to the radio beacon for redemption.

2. The method according to claim 1, wherein the second interface is a wireless interface.

3. The method according to claim 1, wherein the radio beacon is equipped with a public and a private electronic key of the radio beacon, and wherein the decrypted ticket or the ticket derived therefrom is re-encrypted in the onboard unit using the public radio beacon key before transmission to the radio beacon.

4. The method according to claim 3, wherein the ticket or derived ticket is decrypted in the radio beacon using the private radio beacon key.

5. The method according to claim 1, wherein the radio beacon is equipped with a public and a private electronic key of a central system of the traffic telematics system, and wherein the decrypted ticket or the ticket derived therefrom is re-encrypted in the onboard unit using the public central system key before transmission to the radio beacon.

6. The method according to claim 5, wherein the ticket or derived ticket is decrypted in the radio beacon using the private central system key.

7. The method according to claim 1, further comprising:
in a central system of the traffic telematics system provided with a public and a private electronic key:
issuing the ticket,
signing the ticket using the private central system key,
encrypting the ticket using the public onboard unit key, and
transmitting the encrypted ticket to the onboard unit via the second interface thereof.

8. The method according to claim 7, wherein the ticket is validated in the onboard unit by means of the public central system key, and only then, if the ticket is valid, is the ticket or the ticket derived therefrom transmitted to the radio beacon for redemption.

9. The method according to claim 7, wherein the ticket or the ticket derived therefrom is validated in the radio beacon by means of the public central system key and is only then redeemed if the ticket is valid.

10. The method according to claim 7, wherein the public radio beacon key or public central system key is transmitted from the radio beacon to the onboard unit via the DSRC interface.

11. The method according to claim 7, wherein the public central system key is transmitted together with the ticket or the derived ticket.

12. The method according to claim 7, comprising providing the ticket in the central system with a unique identification, checking in the onboard unit whether the identification of a received ticket is contained in a list of stored identifications, and transmitting the ticket or the ticket derived therefrom only then to the radio beacon for redemption if the identification is not contained.

13. The method according to claim 12, wherein the ticket is introduced in the onboard unit into an electronic purse of the onboard unit.

14. The method according to claim 13, wherein the signature of the ticket is validated in the onboard unit by means of the public central system key, and the ticket is only then introduced into the electronic purse if the ticket is valid.

15. The method according to claim 12, wherein the unique identification is a timestamp.

16. The method according to claim 2, wherein the second interface is an NFC (near field communication) interface.

17. The method according to claim 13, wherein the derived ticket is derived from the electronic purse.
